(19) United States
(12) Patent Application Publication
(10) Pub. No.: US 2011/0251886 A1
(43) Pub. Date: Oct. 13, 2011

(54) PROMOTIONAL PLACEMENT OF APPLICATIONS IN A MARKETPLACE

(75) Inventors: Todd Biggs, Kirkland, WA (US); Daniel W. Bouie, Seattle, WA (US); Kamran Rajabi Zargahi, Seattle, WA (US); John P. Bruno, JR., Snoqualmie, WA (US)

(73) Assignee: MICROSOFT CORPORATION, Redmond, WA (US)

(21) Appl. No.: 12/755,911

(22) Filed: Apr. 7, 2010

(51) Int. Cl. G06Q 30/00; G06Q 10/00

(52) U.S. Cl. 705/14.42; 705/14.45

(57) ABSTRACT

Assigning a mobile application to a promotional slot in a mobile application marketplace managed by an operator. One or more bids for the promotional slot in the mobile application marketplace are received. Each of the received bids is associated with one of a plurality of applications and includes a value representing a proposed revenue share with the operator. Revenue potential information corresponding to the applications associated with the bids is accessed. Expected revenue for the operator for the applications associated with the bids is calculated based on the received bids and the accessed revenue potential information. The calculated expected revenue differentiates the mobile applications. One of the applications is selected to be assigned to the promotional slot based at least on the calculated expected revenue for the operator.

### BACKGROUND

Mobile applications are a rapidly developing segment of the mobile market. The mobile applications are designed to run on handheld computers, personal digital assistants (PDAs), smartphones, cellular phones, and other mobile devices. While the devices, platforms, and operating systems that support mobile devices remain integral, mobile applications have emerged as a popular feature for mobile devices. As the popularity of mobile applications continues to rise, the focus has shifted to the independent software vendors (ISVs) providing the mobile applications. For example, where ISVs may traditionally have received 40% of revenue from the sale of mobile applications, ISVs may now receive 70% or more of the revenue from the sale of mobile applications. The resulting change in the economics for mobile developers has created a flood of mobile applications competing for visibility in mobile application marketplaces, as increased visibility often correlates to increased return on investment for ISVs. This forces a downward pricing cycle as ISVs lower pricing of their mobile applications to try to increase visibility and hence downloads. The downward pricing cycle threatens to reduce future investment in mobile applications and to prohibit entry by new ISVs.

Further, some existing mobile application marketplace systems use an auction process to promote mobile applications. The slots are assigned, for example, based on the highest bids received from the ISVs regardless of the ultimate popularity of the mobile applications. As such, the existing systems fail to maximize revenue for the ISVs and for the operator of the mobile application marketplace.

### SUMMARY

Embodiments of the disclosure assign a mobile application to a promotional slot in a mobile application marketplace managed by an operator. One or more bids for the promotional slot in the mobile application marketplace are received. Each of the received bids is associated with one of a plurality of applications and includes a value representing a proposed revenue share with the operator. Revenue potential information corresponding to the applications associated with the bids is accessed. Expected revenue for the operator for the applications associated with the bids is calculated based on the received bids and the accessed revenue potential information. One of the applications is selected to be assigned to the promotional slot based at least on the calculated expected revenue for the operator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram of independent software vendors communicating with a mobile application marketplace via a network.

FIG. 2 is an exemplary block diagram of the mobile application marketplace having a memory area storing information related to mobile applications and computer-executable components.

FIG. 3 is an exemplary flow chart illustrating a process for assigning a mobile application to a promotional slot in a mobile application marketplace managed by an operator.

FIG. 4 is a screen shot of an exemplary user interface enabling independent software vendors to communicate with the mobile application marketplace.

Corresponding reference characters indicate corresponding parts throughout the drawings.

### DETAILED DESCRIPTION

Referring to the figures, aspects of the disclosure operate to place applications within promotional slots in an application marketplace such as a mobile application marketplace. Some embodiments contemplate an assignment process such as an auction in which bids as well as revenue potential for the applications are considered when assigning the applications to the promotional slots. The bids represent proposed revenue sharing between the independent software vendor and an operator of the application marketplace. The revenue sharing occurs on sales of the applications over a defined period of time (e.g., a promotional period).

The differentiated revenue sharing allows independent software vendors 102 access to promotional slots. The promotional slots provide increased visibility which correlates to increased sales (e.g., downloads) of mobile applications. Expanding the assignment process to include revenue potential further helps decrease downward pricing pressure by providing the independent software vendors 102 an opportunity to increase visibility of their mobile applications without lowering the prices. Thus, utilizing differentiated revenue share enables a mobile application marketplace to maintain higher price points across pricing distribution.

While described herein with reference to mobile applications and a mobile application marketplace, aspects of the disclosure are not limited to such embodiments. Rather, aspects of the disclosure contemplate the promotion of any type of application based on revenue sharing and calculated revenue potential.

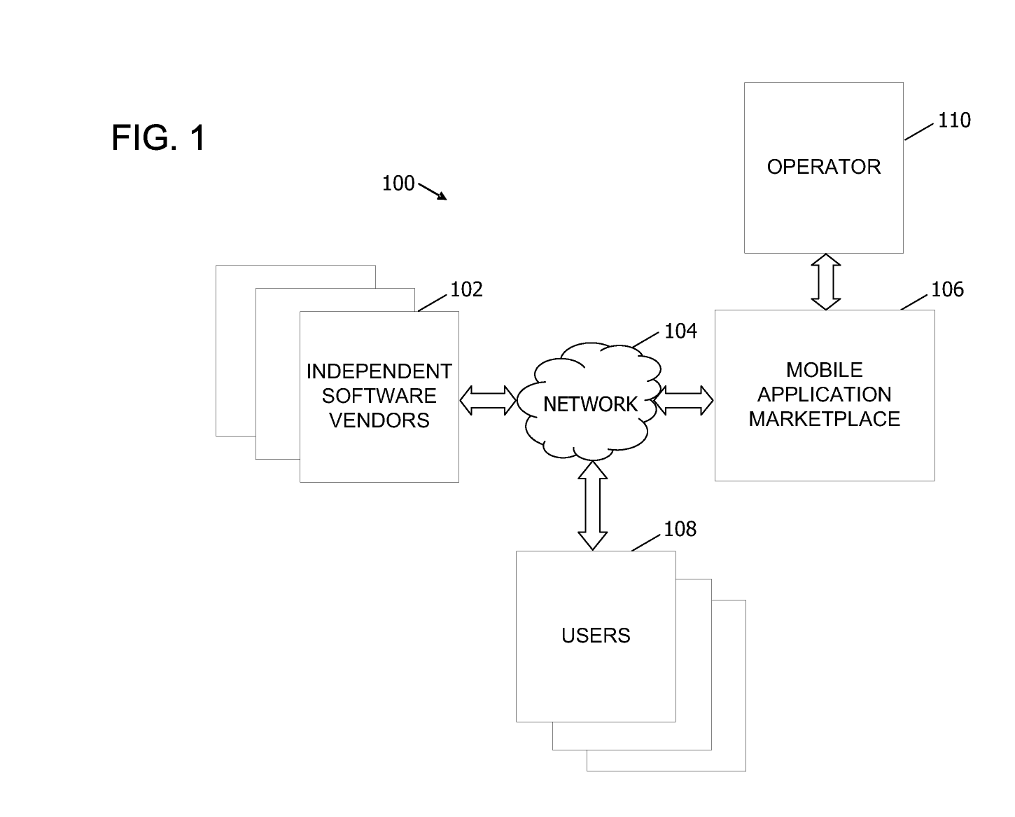

Referring again to FIG. 1, embodiments of the present disclosure provide a system 100 that enables independent software vendors 102 to communicate with a mobile application marketplace 106. The system 100 includes one or more independent software vendors 102, one or more networks 104, the mobile application marketplace 106, a plurality of users 108, and the operator 110. The operator 110 provides the mobile application marketplace 106. The independent software vendors 102 provide the mobile applications to the mobile application marketplace 106 (e.g., via network 104). The users 108 download the mobile applications from the mobile application marketplace 106 (e.g., via network 104). In some embodiments (not shown), the operator 110 accesses the mobile application marketplace 106 via the network 104.

While some embodiments of the disclosure are illustrated and described herein with reference to the mobile application marketplace 106 being provided by one or more servers, aspects of the disclosure are operable with any device or group of devices that performs the functionality illustrated and described herein, or its equivalent, to provide the mobile application marketplace 106.

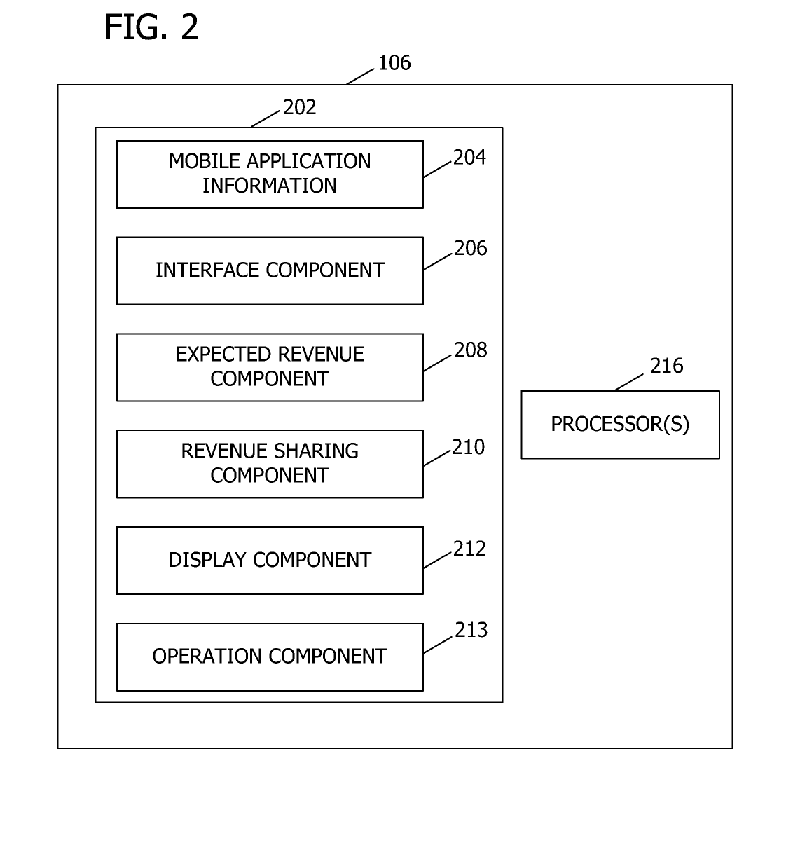

Referring next to FIG. 2, an exemplary block diagram illustrates the mobile application marketplace 106 having a memory area 202 for storing components for assigning a mobile application to a promotional slot in the mobile application marketplace 106. The mobile application marketplace 106 includes a memory area 202 and at least one processor 216. The memory area 202 stores mobile application information 204 and one or more computer-executable components. The mobile application information 204 includes, for example, revenue potential information describing the potential revenue associated with each of the mobile application.

Exemplary components include, but are not limited to, an interface component 206, an expected revenue component 208, a revenue sharing component 210, a display component 212, and an operation component 213. While the mobile application information 204 and components 206-213 are shown to be stored in memory area 202, the mobile application information 204 and components 206-213 may be stored and executed from a memory area remote from the mobile application marketplace 106. For example, the mobile application information 204 may be stored in a cloud service, a database, or other memory area accessible by the mobile application marketplace 106. Such embodiments reduce the computational and storage burden on the mobile application marketplace 106.

Processor 216 executes computer-executable instructions for implementing aspects of the disclosure. In some embodiments, the processor 216 is transformed into a special purpose microprocessor by executing computer-executable instructions or by otherwise being programmed. For example, the operation component 213, when executed by the processor 216, causes the processor 216 to provide a platform for selling, assigning, or otherwise filling the promotional slot. The interface component 206, when executed by the processor 216, causes the processor 216 to receive one or more bids for a promotional slot in the mobile application marketplace 106. The promotional slot may include, for example, differentiated placement or ranking in a list of applications, differentiated position in a web page, or other differentiated display (e.g., highlighting, underlining, font, color, etc.).

The interface component 206 further causes the processor 216 to access revenue potential information corresponding to mobile applications associated with the bids. In embodiments, each of the received bids is associated with one of a plurality of mobile applications and includes a value representing a proposed revenue share with the operator 110. In further embodiments, revenue potential information may include one or more of the following for each mobile application associated with the bids: a price of a mobile application, a rating of a mobile application, a quantity of previous sales of a mobile application, performance of each category associated with a mobile application, a quantity of days a mobile application has been on the market, a velocity of sales associated with a mobile application, and popularity or reputation of the independent software vendor 102.

The expected revenue component 208, when executed by the processor 216, causes the processor 216 to calculate an expected revenue for the operator 110 for the mobile applications associated with the bids based on the received bids and the accessed mobile application information 204. The expected revenue component 208 further causes the processor 216 to select one of the mobile applications to be assigned to the promotional slot based at least on the calculated expected revenue for the operator 110.

The display component 212, when executed by the processor 216, causes the processor 216 to place the selected mobile application in the promotional slot for display to users 108 of the mobile application marketplace 106.

Execution of the revenue sharing component 210 by the processor 216 causes the processor 216 to allocate revenue from sales of the selected mobile application in accordance with the proposed revenue share associated with the selected mobile application. In further embodiments, the revenue sharing component 210 subsequently compares actual revenue of the selected mobile application with the calculated expected revenue for that selected mobile application. The results of the comparison are provided to the operator 110 for evaluation. The results may be used, for example, to adjust the method by which the expected revenue is calculated (e.g., altering the weights of the various data from the revenue potential information).

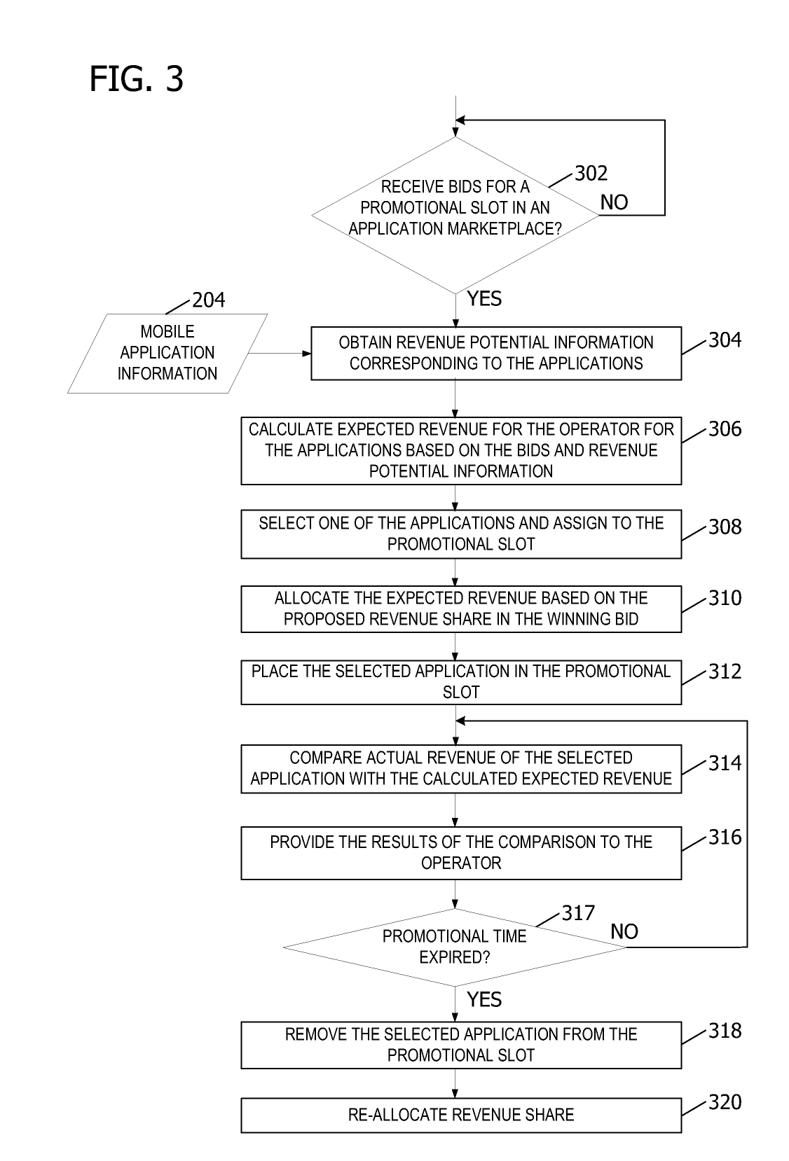

Referring next to FIG. 3, an exemplary flow chart illustrates a process for assigning a mobile application to a promotional slot in the mobile application marketplace 106. The process includes determining whether one or more bids for a promotional slot in the mobile application marketplace 106 are received at 302. The independent software vendors 102 select the slot on which to bid. In embodiments, each of the bids is associated with one of a plurality of mobile applications and includes a value representing a proposed revenue share with the operator 110. Each of the bids may also include a defined period of time during which an independent software vendor desires a mobile application to be placed in the promotional slot. In other embodiments, the operator 110 defines a predefined period of time the mobile application is assigned to the promotional slot.

At 304, the mobile application information 204 is accessed to obtain revenue potential information corresponding to the mobile applications associated with the bids. While in some embodiments revenue sharing is used by itself to assign one of the mobile applications to a particular promotional slot, other factors in other embodiments are also considered to determine the placement. For example, other factors may include, but are not limited one or more of the following for each mobile application associated with the bids: a price of a mobile application; a rating of a mobile application; a quantity of previous sales of a mobile application; performance of each category associated with a mobile application; a quantity of days a mobile application has been on the market; a velocity of sales associated with a mobile application, a quantity of reviews (positive or negative), a percent of views that result in a download, and a quantity of returns/refunds. Weighting and combining these factors to assign one of the mobile applications to the promotional slot enables promotion of applications in different ways. Further, incorporating these other factors enables the mobile application marketplace 106 to present high-quality mobile applications in promotional slots within the mobile application marketplace 106, thus maximizing revenue to the operator 110. In some embodiments, the operator 110 assigns the weighting and performs the combining of the factors, and performs other operations to determine the winning bid.

At 306, expected revenue for the operator 110 is calculated for the mobile applications associated with the bids. These calculations may be based on the received bids and the accessed revenue potential information described above. For example, the various items of revenue potential information as described herein may be weighted and combined with the proposed revenue share from the bids to produce a score, rank, or other indicator of expected revenue for the mobile applications.

At 308, one of the mobile applications is selected and assigned to the promotional slot based at least on the calculated expected revenue for the operator 110. At 310, the mobile application marketplace 106 is configured such that revenue to be received from sales of the selected application is allocated based on the proposed revenue share associated with the selected application. At 312, the selected mobile application is placed in the promotional slot. In some embodiments, operation 312 occurs before or simultaneously with operation 310.

For reporting or other purposes, the actual revenue from sales of the selected mobile application during the promotional time period may be compared at 314 to the calculated expected revenue of the selected mobile application. At 316, the results of the comparison are provided or presented to the operator 110 (e.g., a user) for evaluation. If the promotional time period has expired at 317, the selected mobile application is removed at 318 from the promotional slot. The promotional time period includes, for example, a predefined period of time selected by the operator 110 or a period of time proposed by the independent software vendor associated with the selected mobile application.

Upon expiration of the promotional time period, the revenue share is re-allocated at 320. For example, a percentage of revenue of the selected mobile application is adjusted or set back to the percentage of revenue (e.g., an original percentage) in existence prior to placement of the mobile application in the promotional slot. In further embodiments, the selected mobile application may enjoy the benefits of the now-vacated promotional slot during a “cool-down” time period (e.g., several days) following expiration of the promotional time period. For example, the selected mobile application may appear higher in search results based on popularity, top sellers, or other filters throughout the mobile application marketplace 106 (e.g., on-device, web portal, or other client). In such embodiments, the revenue share may be re-allocated at 320 step-wise during the cool-down period. For example, the revenue share may be adjusted several times on the way to the original revenue share. Such embodiments compensate the operator 110 for the benefits provided to the selected mobile application after the promotional time period.

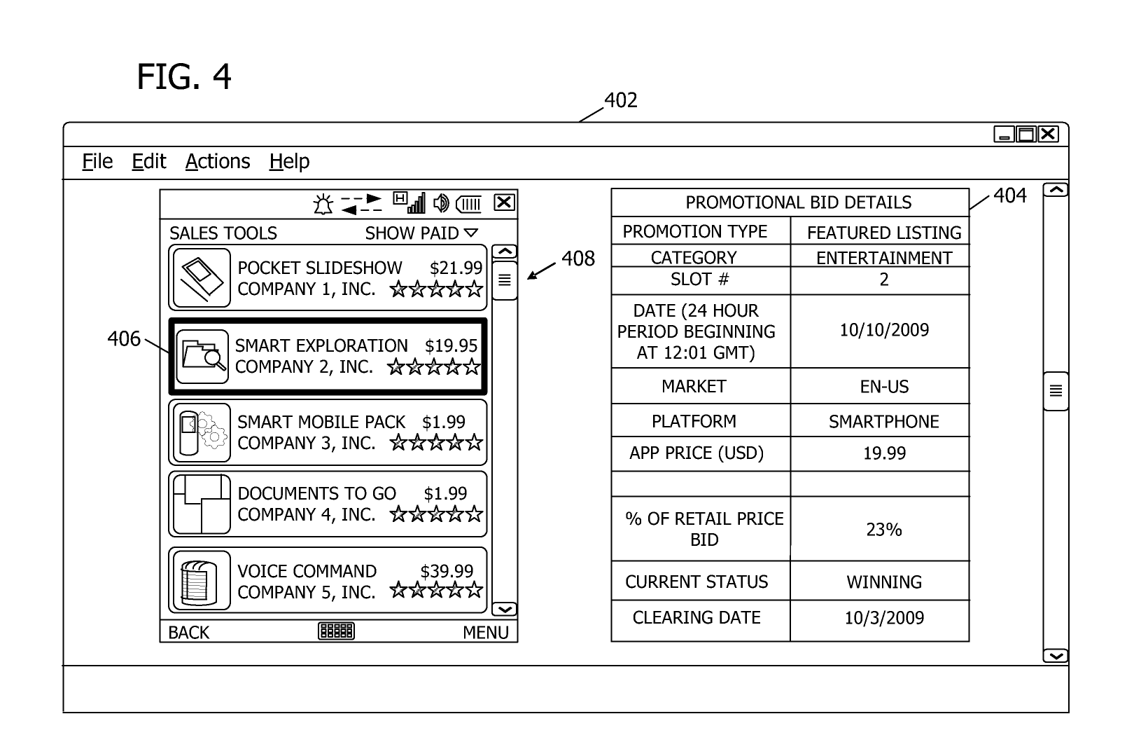

Referring next to FIG. 4, a screen shot 402 of an exemplary user interface enabling independent software vendors 102 to communicate with the mobile application marketplace 106 is provided. As illustrated in FIG. 4, an independent software vendor such as Company 2, Inc. accesses a developer portal that enables submission of mobile applications for placement within the mobile application marketplace 106. Portion 408 of the screen shot 402 illustrates granular promotional slots available for particular time periods within particular markets. For example, portion 408 includes promotional slot 406. In the example of FIG. 4, promotional slot 406 shows a mock-up of the “Smart Exploration” mobile application to illustrate the possible placement to Company 2, Inc.

For the purpose of this example, the revenue share between Company 2, Inc. and the operator 110 is 70/30. That is, initially (e.g., before bidding on the promotional slot 406 or other available promotional slot), 70% of the revenue from sales of “Smart Exploration” is allocated to Company 2, Inc. and 30% of the revenue is allocated to the operator 110.

Within the developer portal, a differentiated revenue share user interface control may be accessed by Company 2, Inc. through several form factors. In one embodiment, there may be a field that indicates a current revenue share (e.g., 70%) that can be edited, or there may be a drop down list of revenue share options (e.g., 40%, 50%, 60%, and the like). In a further embodiment, there may be a “slider bar” or dial illustrating a current revenue share setting enabling adjustment of the revenue share for a particular mobile application. Additionally, in combination with one or more of the above, Company 2, Inc. may dynamically bid a revenue share of a mobile application against other independent software vendors 102 for specific promotional slots within specific markets at specific times.

Portion 404 of the screen shot 402 illustrates current bidding details for a promotional slot 406. Details of the current bid illustrated in FIG. 4 include, but are not limited to, promotion type (“featured listing”), category (“entertainment”), slot number (“2”), available dates/times (“Oct. 10, 2009 for 24 hrs”), market (“EN-US”), platform (“smartphone”), price of mobile application (“$19.99”), proposed percentage of revenue share (“23%”), current status (“winning”), and a clearance date (“Oct. 3, 2009”).

In other embodiments (not shown), the promotional slot 406 appears as a header, footer, sidebar, or any combination thereof in the list of mobile applications,

While embodiments of the disclosure described herein have been directed to mobile applications, aspects of the disclosure are not limited to enhanced placement of mobile applications in a mobile application marketplace. For example, embodiments of the disclosure are operable with enhanced placement of information relating to any product and/or service on a web page or other means for presenting the product and/or service for purchase.

### Exemplary Operating Environment

A computer or computing device such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

The computer may operate in a networked environment using logical connections to one or more remote computers, such as a remote computer. Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for calculating an expected revenue of mobile applications, and exemplary means for calculating a percentage of expected revenue from a selected mobile application based on an increase in popularity of the selected mobile application during a predefined period of time.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for assigning a mobile application to a promotional slot in a mobile application marketplace managed by an operator, said system comprising:
a memory area for storing information related to mobile applications, said information comprising one or more of the following for each of the mobile applications: a price of the mobile application; a rating of the mobile application; a quantity of previous sales of the mobile application; performance of each category associated with the mobile application; a quantity of days the mobile application has been on the market; and a velocity of sales associated with the mobile application; and
a processor programmed to:
receive one or more bids for the promotional slot, wherein each of the bids is associated with one of the mobile applications and includes a value representing a proposed revenue share with the operator;
access the memory area for the information corresponding to the mobile applications associated with the received bids;
calculate an expected revenue for the operator based on the received bids and the accessed information; and
select one of the mobile applications to assign to the promotional slot based at least on the calculated expected revenue for the operator.

2. A system of claim 1, wherein the processor is further programmed to:
allocate the expected revenue based on the proposed revenue share associated with the selected mobile application; and
place the selected mobile application in the promotional slot.

3. A system of claim 1, further comprising means for calculating the expected revenue of the mobile applications.

4. A system of claim 1, wherein assignment to the promotional slot is for a predefined period of time.

5. A system of claim 4, further comprising means for calculating a percentage of expected revenue from the selected mobile application based on an increase in popularity of the selected mobile application during the predefined period of time.

6. A method comprising:
receiving one or more bids for a promotional slot in an application marketplace managed by an operator, wherein each of the received bids is associated with one of a plurality of applications and includes a value representing a proposed revenue share with the operator;
accessing revenue potential information corresponding to the applications associated with the bids;
calculating an expected revenue for the operator for the applications associated with the bids based on the received bids and the accessed revenue potential information; and
selecting one of the applications to assign to the promotional slot based at least on the calculated expected revenue for the operator.

7. A method of claim 6, wherein the revenue potential information comprises one or more of the following for each of the applications: a price of the application; a rating of the application; a quantity of previous sales of the application; performance of each category associated with the application; a quantity of days the application has been on the market; and a velocity of sales associated with the application.

8. A method of claim 6, wherein each of the plurality of applications is a mobile application.

9. A method of claim 6, wherein each of the one or more bids comprises a proposed period of time for sharing the proposed revenue share with the operator.

10. A method of claim 9, further comprising:
allocating the expected revenue based on the proposed revenue share associated with the selected application; and
placing the selected application in the promotional slot for the proposed period of time.

11. A method of claim 10, further comprising:
removing the selected application from the promotional slot after the proposed period of time; and
setting a percentage of revenue of the selected application back to a percentage of revenue prior to the selection of the application.

12. A method of claim 10, further comprising:
removing the selected application from the promotional slot after the proposed period of time; and
setting a percentage of expected revenue from the selected application based on an increase in popularity of the selected application during the proposed period of time.

13. A method of claim 6, further comprising:
comparing actual revenue of the selected application with the calculated expected revenue of the selected application; and
providing results of the comparing to a user.

14. One or more computer-readable media having computer-executable components, said components comprising:
an interface component for receiving one or more bids for a promotional slot in an application marketplace managed by an operator, and for accessing revenue potential information corresponding to the applications associated with the bids, wherein each of the received bids is associated with one of a plurality of applications and includes a value representing a proposed revenue share with the operator;
an expected revenue component for calculating an expected revenue for the operator for the applications associated with the bids based on the received bids and the accessed revenue potential information, and selecting one of the applications to assign to the promotional slot based at least on the calculated expected revenue for the operator; and
a revenue sharing component for allocating revenue from sales of the selected application based on the proposed revenue share associated with the selected application.

15. The computer-readable media of claim 14, further comprising an operation component for providing a platform for selling the promotional slot.

16. The computer-readable media of claim 14, wherein each of the one or more bids comprises a proposed period of time for sharing the proposed revenue share with the operator.

17. The computer-readable media of claim 14, wherein the revenue potential information comprises one or more of the following for each of the applications: a price of the application; a rating of the application; a quantity of previous sales of the application; performance of each category associated with the application; a quantity of days the application has been on the market; and a velocity of sales associated with the application.

18. The computer-readable media of claim 14, further comprising a display component for placing the selected application in the promotional slot for display to users of the application marketplace.

19. The computer-readable media of claim 14, wherein the revenue sharing component allocates a percentage of revenue from sales of the selected application during the predefined period of time based on the proposed revenue share.

20. The computer-readable media of claim 19, wherein the revenue sharing component compares the revenue from the sales of the selected application with the calculated expected revenue of the selected application and further provides results of the comparison to the operator.
